(19) United States
(12) Patent Application Publication
(10) Pub. No.: US 2004/0083049 A1
(43) Pub. Date: Apr. 29, 2004

(54) Motor vehicle with a device for recognizing the current status of a traffic signal

(76) Inventor: Hans Joachim Fuchs, Dorfprozelten (DE)

Correspondence Address: MCGLEW & TUTTLE, PC, 1 SCARBOROUGH STATION PLAZA, SCARBOROUGH, NY, 10510-0827, US

(21) Appl. No.: 10/688,226

(22) Filed: Oct. 16, 2003

(30) Foreign Application Priority Data
Oct. 23, 2002 (DE) DE 102 49 512.2

(51) Int. Cl. G06F 17/00

(52) U.S. Cl. 701/117; 701/1

(57) ABSTRACT

A motor vehicle (01) has a device for recognizing the current status of a traffic signal (03), a control unit (06) in which the output signal of the device can be processed, and a signaling device (07, 16). The signaling device (07, 16) is arranged in the motor vehicle (01) and is able to signal the current status of the traffic signal (03) to the driver in an optically and/or acoustically and/or haptically perceivable fashion.

### FIELD OF THE INVENTION

The invention pertains to a motor vehicle with a device for recognizing the current status of a traffic signal.

### BACKGROUND OF THE INVENTION

In daily road traffic, it frequently occurs that the driver of a motor vehicle is, if it all, only able to determine the status of a traffic signal with great difficulty, e.g., if the traffic signal is arranged in the region of a curve, if the view of the traffic signal is blocked by tall vehicles, if the view of the traffic signal is blocked by the own motor vehicle while it is stopped directly in front of the traffic signal or if the view of the traffic signal is impaired by the glare caused by incident sunlight. In addition, different signal statuses must be expected if several traffic lanes are provided (left/right turns, variable turns for controlling the traffic flow). In order to detect motor vehicles in the respective traffic lanes, induction loops are embedded into the roads, with said induction loops controlling the traffic signal in dependence on the traffic volume. These induction loops may also be used as radiating antennas for transmitting information by suitably superimposing the information signal on the oscillating circuit. There also exist traffic signal systems in which the presence of a motor vehicle in front of the traffic signal can be detected by means of infrared detectors.

A method and a device for recognizing object colors are known from DE 198 38 806 A1.

In this method for recognizing objects, in particular, object colors, data or an image is recorded and video data are obtained from an image of a scene. In addition, a color classification for at least one predetermined object is carried out, wherein an essentially constant average color parameter for the entire object is assigned to a certain color class among a series of color classes in a predetermined color space by a fuzzy clustering method and/or a fuzzy control classification.

### SUMMARY OF THE INVENTION

The present invention is based on the objective of proposing a motor vehicle that is equipped with a device for recognizing the current status of a traffic signal.

According to the invention, a device for recognizing the current status of a traffic signal is arranged in the motor vehicle according to the invention. The motor vehicle is also provided with a control unit in which the output signal of the device can be processed, as well as with a signaling device that is arranged in the motor vehicle and serves for signaling the current status of the traffic signal to the driver of the motor vehicle in an optic and/or acoustic and/or haptic fashion. Systems operating in a haptic fashion act on a person's tactile sense.

This means that the driver of the motor vehicle can already be informed, of the current status of a traffic signal when the motor vehicle approaches the traffic signal. In order to achieve a better perception, the optical signal can be output acoustically and/or haptically. Naturally, it would also be conceivable to merely output the signal either in an optic or acoustic or haptic fashion. According to the invention, it is not important whether the signals are output individually or in combination.

However, it would also be possible to provide the individual phases of the traffic signal with acoustic signals or time indications so as to inform the driver when the green light phase or the red light phase begins or ends. For example, it would be conceivable to inform the driver of the time remaining until the next switching phase in the form of a time indication. The time intervals may naturally also be displayed optically. A counter or the like would make it possible to display the seconds remaining until the next switching phase. In this case, an additional development of the device makes it possible to take into account the requirements and desires of the respective driver.

The device that receives the status signal transmitted by the traffic signal is realized in the form of a radio receiver and advantageously mounted on the outside of the motor vehicle. In this case, it would be advantageous to integrate the radio receiver into the antenna of the motor vehicle. Naturally, it would also be conceivable to separately install the radio receiver on the motor vehicle or to integrate the radio receiver into the interior of the motor vehicle. In this respect, other variations may also be considered. The traffic signal, for instance, can emit the appropriate radio signals only within a limited radius. For example, the Bluetooth protocol would constitute a suitable communication protocol. As an alternative broadband communication systems are conceivable which may operate in particular via satellite. These broadband communication systems can be controlled by means of traffic routing systems in a town or region or other telematics systems.

The device may also be realized in the form of a color-sensitive light receiver that directly detects the light emitted by the traffic signal if the traffic signal does not allow a wireless data transmission or if no induction loops are embedded in the individual traffic lanes.

For example, if an optical sensor is used, the light emitted by the traffic signal can be split into its spectral colors (red, green, blue), and their percentage of the total light can be calculated by means of photodiodes. The thus determined intensities make it possible to identify colors, anal the current status of the traffic signal can be determined without interfering influences.

A three-element color sensor may also be used. In sensors of this type, the color recognition is realized by means of the three-area method that simulates the human eye. The color-sensitive light receiver may be realized in the form of a color camera. The transmitted images of the respective traffic signal status can be illustrated on a display device in this case. The current status of the traffic signal that may also be coupled with a time indication for the next switching phase in this case can be visually illustrated to the driver on a display device.

It would also be conceivable to process the recorded images of the color camera in a computer, with the processed images being stored in the form of video data. The obtained video data can, be analyzed and converted with the aid of image processing programs. The video data can be filtered by means of a color recognition process and utilized in such a way that different colors are illustrated on the display device.

The signaling device may be realized in the form of an actuating element that acts upon the steering wheel when the motor vehicle approaches the traffic signal.

In this respect, it would be conceivable for the actuating element to transmit a vibrating movement onto the steering wheel. This means that the driver is haptically informed when the status of the traffic signal changes. This system has the advantage that the driver can also be notified of the motor vehicle approaching a traffic signal and of the imminent switching phase of the traffic signal while loud music is played or while the driver makes a telephone call. Due to these measures, the driver can practically be prevented from running a red light while being distracted or simply not paying attention.

When using an optical signaling device, it would be conceivable to arrange the display device on the inside rearview mirror. The display device could also be arranged on the mounting bracket or the frame of the inside rearview mirror or even on the mirror surface itself and preferably displays the different colors of the traffic signal.

Another option consists of providing an inside rearview mirror that is realized in a semi-transparent fashion with an electroluminescent foil over at least part of its surface area. For example, this foil is attached to the rear of the reflective glass of the inside rearview mirror and can be illuminated in certain parts of the surface area in an electrically controlled fashion. The foil consists of an extruded or coextruded foil with a pigment percentage of up to 70 vol. % referred to the total volume of the foil. The foil usually contains two or more different electroluminescent pigment types.

This foil makes it possible to display a color symbol or an arrangement of different colors. This foil may also be arranged in a certain area of the dashboard or the outside mirror.

Light-emitting diodes of different colors may also be provided in the display device, with the light-emitting diodes advantageously being arranged such that they correspond to a traffic signal.

According to another conceivable embodiment, the inside rearview mirror of the motor vehicle is provided with an internal display device. This display device could, for example, be arranged in the mounting bracket of the inside rearview mirror. A traffic signal could be symbolized by arranging the three light-emitting diodes underneath one another or adjacent to one another, respectively. This would make it possible for the driver to rapidly ascertain the switching phase of the traffic signal. The next switching phase could also be announced by an acoustic signal in this case.

It would also be conceivable to design the display device in such a way that it can be individually positioned in the motor vehicle depending on the desire or ergonomics of the driver. A plug-type or magnetic connection on the display device could be advantageously provided for this purpose.

Two embodiments of the invention are illustrated in the figures and described in greater detail below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a schematic representation showing the functional principle of the motor vehicle according to the invention;

FIG. 2 is top view showing the functional principle according to FIG. 1;

FIG. 3 is a schematic representation showing a first embodiment of a signaling device;

FIG. 4 is a sectional representation showing the signaling device according to FIG. 3; and

FIG. 5 is a schematic representation showing a second embodiment of a signaling device.

### DESCRIPTION OF THE PREFERRED EMBODIMENT

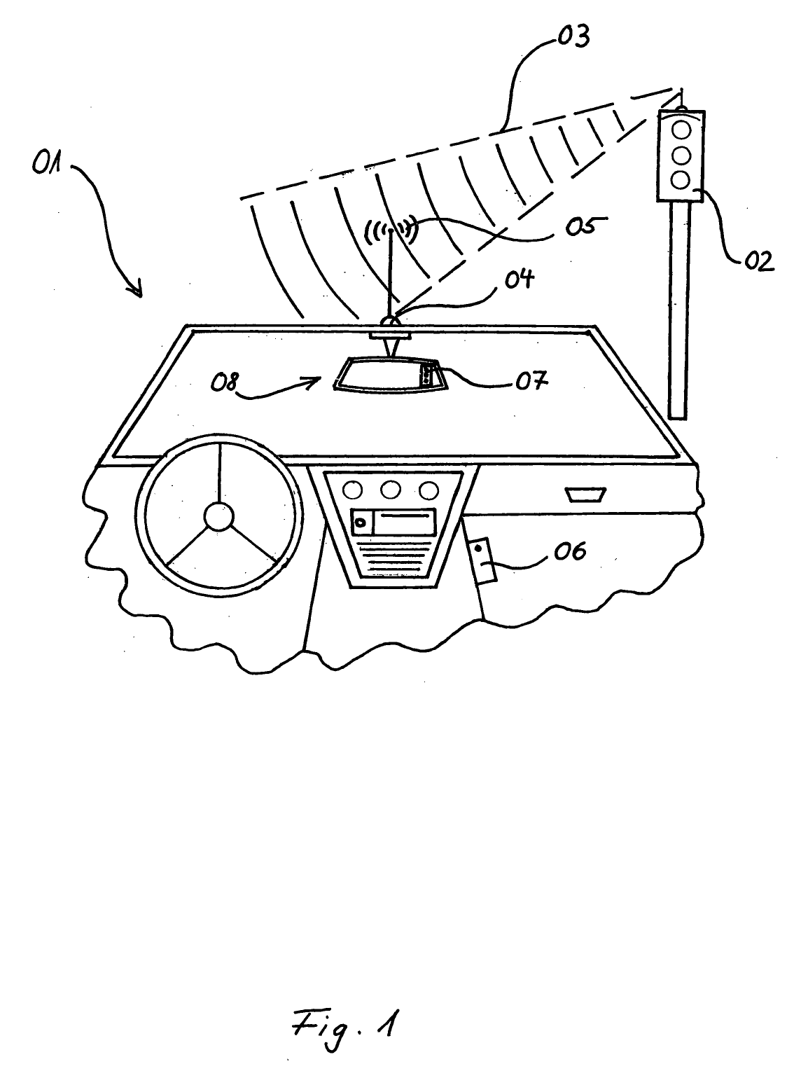

Referring to the drawings in particular, FIG. 1. shows a schematic representation of the functional principle according to the invention. The currently illuminated color of a traffic signal 02 is coded as a radio signal 03 and directly transmitted by means of an antenna provided at the traffic signal or an induction loop embedded in the respective lane. The radio signal 03 transmitted by the traffic signal 02 is received by a device provided with a sensor 04. The sensor 04 on the motor vehicle 01 forwards the sensor signals 05 to a control unit 06. The data processed in the control unit are then displayed on a signaling device 07 that is arranged on the inside rearview mirror 08 of the motor vehicle 01 in the embodiment shown.

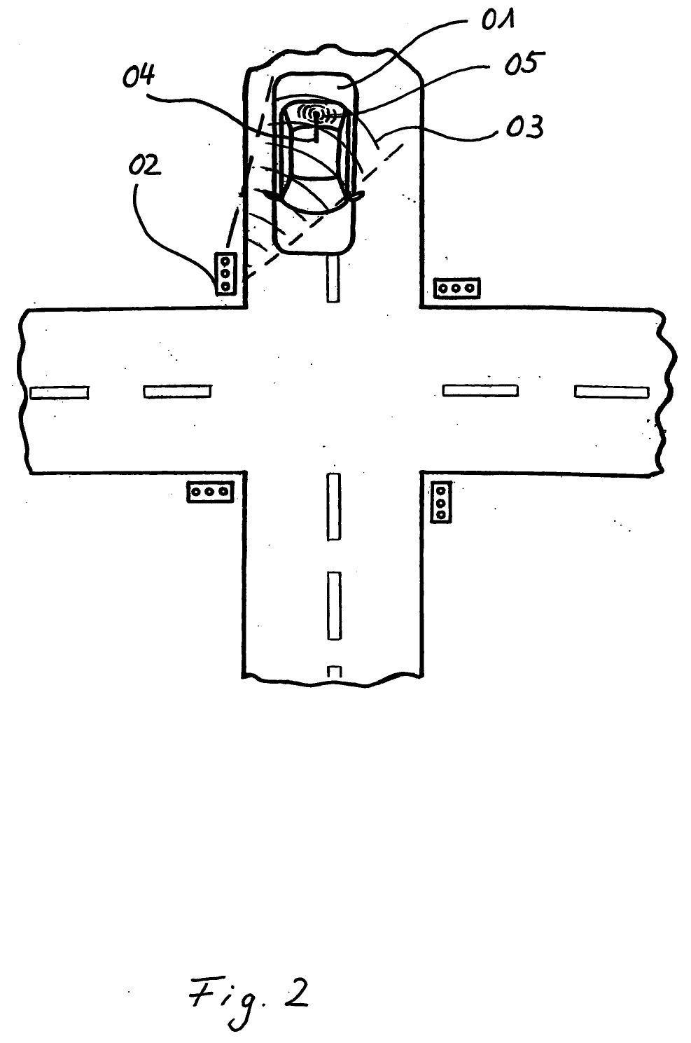

FIG. 2 shows a schematic top view of the functional principle of the motor vehicle 01. The motor vehicle 01 is stopped at a traffic signal 02 and receives the radio signals 03 transmitted by the traffic signal 02. The sensor 04 that is situated on the roof of the motor vehicle 01 or another suitable location receives signals 03 of the traffic signal and forwards the sensor signals 05.

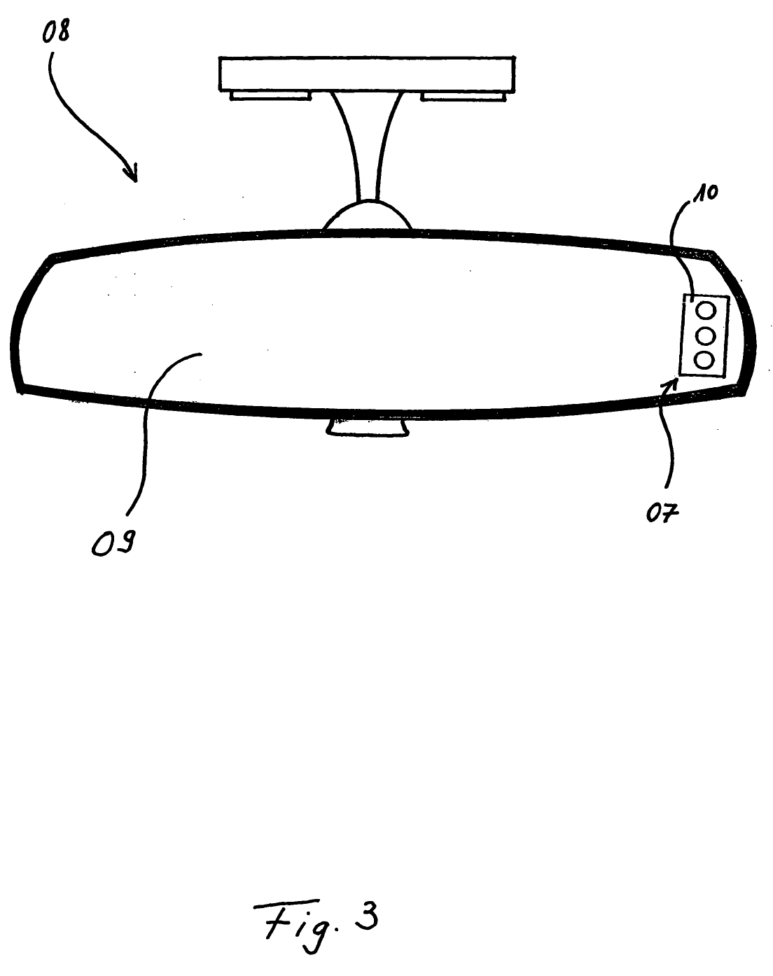

FIG. 3 shows the signaling device 07. The signaling device 07 is integrated into the inside rearview mirror 08. The signaling device 07 that is realized in the form of an electroluminescent foil 10 in this embodiment is situated behind the reflective glass 09. Certain parts of the surface area of the electroluminescent foil 10 can be illuminated by means of electric pulses. A traffic signal symbol can be displayed to the driver on the inside rearview mirror 08 in this fashion.

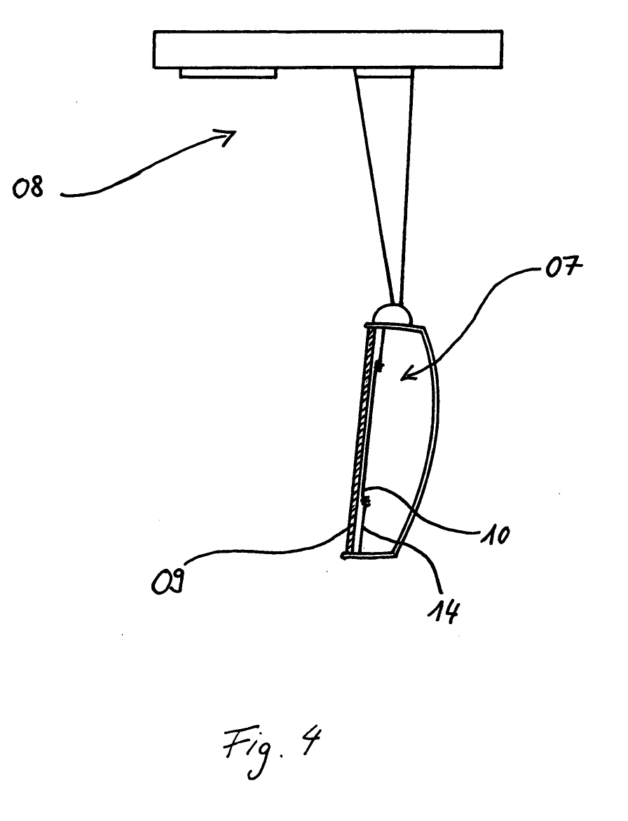

FIG. 4 shows the inside rearview mirror 08 with the signaling device 07 according to FIG. 3 in the form of a schematic sectional representation. The electroluminescent foil 10 is situated behind the reflective glass 09. This electroluminescent foil 10 is attached to the rear side of the reflective glass 09 and connected to a control unit by means of contacts 14 such that it can be electrically controlled.

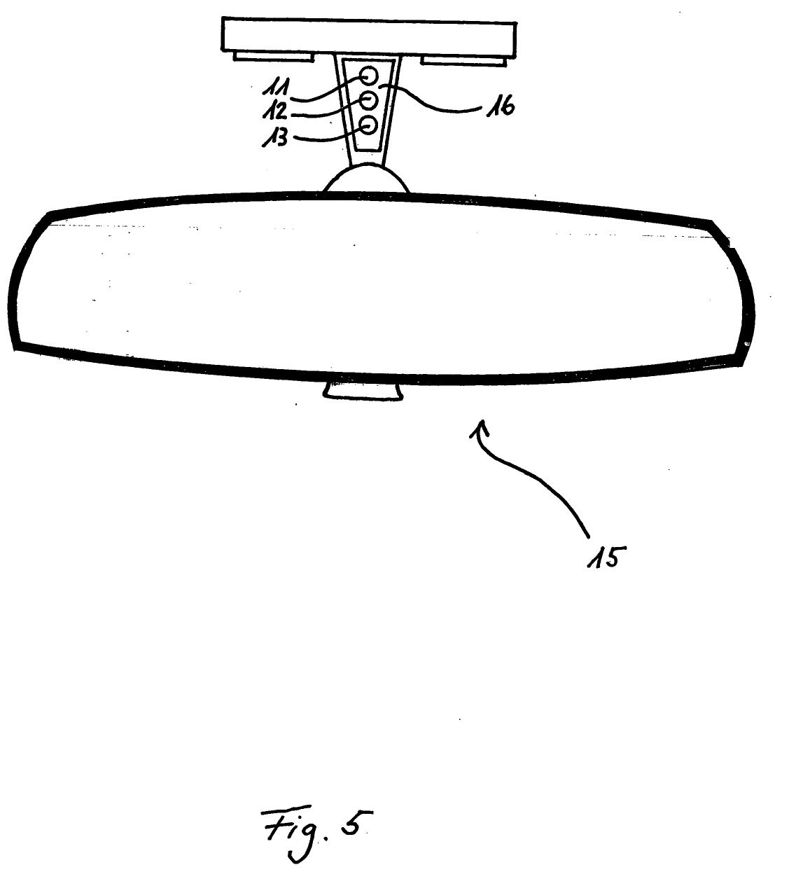

FIG. 5 shows a second embodiment 16 of an inside rearview mirror that is provided with a signaling device 15. In this case, the signaling device 15 is integrated into the mounting bracket of the inside rearview mirror 16. The signaling device 15 is formed by three light-emitting diodes 11, 12 and 13 in this embodiment.

While specific embodiments of the invention have been shown and described in detail to illustrate the application of the principles of the invention, it will be understood that the invention may be embodied otherwise without departing from such principles.

What is claimed is:

1. A motor vehicle comprising:
a device for recognizing the current status of a traffic signal;
a control unit in which the output signal of the device can be processed;
a signaling device arranged in the motor vehicle and able to signal the current status of the traffic signal to the driver in an optically and/or acoustically and/or haptically perceivable fashion.

2. The motor vehicle according to claim 1, wherein the device comprises a radio receiver for receiving radio signals transmitted by the traffic signal.

3. The motor vehicle according to claim 1, wherein the device comprises a three-element color sensor.

4. The motor vehicle according to claim 1, wherein the device comprises a color-sensitive light receiver for detecting the radio signal or light signal emitted by the traffic signal.

5. The motor vehicle according to claim 4, wherein the color-sensitive light receiver comprises a color camera.

6. The motor vehicle according to one of claim 1, wherein the signaling device comprises an actuating clement that acts upon the steering wheel.

7. The motor vehicle according to claim 6, wherein a vibrating movement can be transmitted onto the steering wheel by means of the actuating element.

8. The motor vehicle according to claim 1, wherein the signaling device comprises a display device that is arranged on the inside rearview mirror.

9. The motor vehicle according to claim 8, wherein that the different colors of a traffic signal can be illustrated on the display device.

10. The motor vehicle according to claim 8, wherein an electroluminescent element, in the form of an electroluminescent foil is provided on the display device.

11. The motor vehicle according to claim 8, wherein light-emitting diodes of different colors are provided on the display device.

12. An inside rearview mirror system for a vehicle, the system comprising:
a device for recognizing the current status of a traffic signal;
a control unit in which the output signal of the device can be processed;
an inside rearview mirror with a signaling device arranged in the motor vehicle and able to signal the current status of the traffic signal to the driver.

13. The system according to claim 12, wherein the signaling device comprises a display device that is arranged on the inside rearview mirror.

14. The system according to claim 13, wherein that the different colors of a traffic signal can be illustrated on the display device.

15. The system according to claim 13, wherein an electroluminescent element, in the form of an electroluminescent foil is provided on the display device.

16. The system according to claim 13, wherein light-emitting diodes of different colors are provided on the display device.
